(19) United States
(12) Patent Application Publication
(10) Pub. No.: US 2020/0320816 A1
(43) Pub. Date: Oct. 8, 2020

(54) TRANSPORTABLE VOTING SYSTEM

(71) Applicant: Election Works, Inc., Geneva, IL (US)

(72) Inventors: Sandy Hed, Geneva, IL (US); Joe Bean, San Diego, CA (US)

(21) Appl. No.: 16/839,506

(22) Filed: Apr. 3, 2020

Related U.S. Application Data
(60) Provisional application No. 62/799,894, filed on Apr. 5, 2019.

(51) Int. Cl. G07C 13/02

(52) U.S. Cl. CPC G07C 13/02

(57) ABSTRACT

A transportable voting system includes a housing having a front, a rear, a top, a bottom, a first side, a second side, and a defined interior. The system also includes a plurality of caster wheels coupled to the housing and a plurality of voting portals arranged in the housing. Each of the plurality of portals includes a user interface and user inputs configured to provide a voting function. A plurality of doors is associated with each of the plurality of voting portals. When the plurality of doors is located in an open position, each of the plurality of voting portals is accessible for performing a voting function. When the plurality of doors is located in their closed position, each of the plurality of voting portals is inaccessible.

### RELATED APPLICATIONS

This application claims priority to U.S. Provisional Patent Application Ser. No. 62/799,894, filed Apr. 5, 2019, the disclosure of which is hereby incorporated by reference in its entirety.

### FIELD OF THE DISCLOSURE

The present disclosure relates to a voting system, and in particular to a voting system that is incorporated into a transportable housing that accommodates equipment necessary to perform a voting function.

### BACKGROUND

Many people visit polling stations each year to cast a vote for a particular political candidate, a judge or other judicial candidate, a school board member, new laws, budgets, and the like. Most of these polling stations are temporarily setup in locations where voting will take place, such as at a library, church, school, or other locations. These conventional polling stations are robust, but may be folded into a collapsed position for transporting to a new location or storage. These conventional stations, however, are heavy and not easily transportable.

Thus, there is a need for a transportable voting system that includes all of the necessary equipment for performing a voting function, but which is easier to maneuver and transport to multiple locations.

### SUMMARY

In one embodiment of the present disclosure, a transportable voting system includes a housing including a front, a rear, a top, a bottom, a first side, and a second side, where the front, rear, top, bottom, first side, and second side define an interior of the housing; a plurality of caster wheels coupled to the housing for rolling along a ground surface during transport; a plurality of voting portals arranged in the housing, each of the plurality of portals including a user interface and user inputs configured to provide a voting function; and a plurality of doors associated with each of the plurality of voting portals, the plurality of doors being movably coupled to the housing; wherein, the plurality of doors are movable between an open position and a closed position; wherein, when the plurality of doors is located in their open position, each of the plurality of voting portals is accessible for performing a voting function and the plurality of doors are configured to provide privacy to each voting portal; further wherein, when the plurality of doors is located in their closed position, each of the plurality of voting portals is inaccessible.

In one example of this embodiment, each of the plurality of voting portals comprises a screen and at least one user input for casting a vote. In a second example, the plurality of voting portals are arranged in the interior of the housing. In a third example, at least one voting portal is located in the front and a second voting portal is located in one of the first side and second side. In a fourth example, at least two voting portals are located in the front.

In a fifth example, the plurality of voting portals comprises a first voting portal, a second voting portal, and a third voting portal, where the first voting portal is located in the front, the second voting portal is located in the first side, and the third voting portal is located in the second side. In a sixth example, a fourth voting portal of the plurality of voting portals is located in the front adjacent the first voting portal. In a seventh example, the plurality of doors comprises a first pair of doors and a second pair of doors, the first pair of doors covering the first voting portal in the closed position and the second pair of doors covering the fourth voting portal in the closed position.

In an eighth example, an additional voting portal is located in the rear. In a ninth example, each of the plurality of doors is movable to its open position and oriented in a substantially perpendicular arrangement relative to the housing to form a privacy shield around the respective voting portal. In a tenth example, a printer is provided for each of the plurality of voting portals. In a further example, the plurality of voting portals includes at least a first voting portal and a second voting portal, the first voting portal and second voting portal arranged in the housing at different heights such that the voting portal at a lower height is configured to be accessed by a wheelchair-bound user. In yet a further example, the voting portal at the lower height includes a pad and a headset.

In another embodiment, a transportable voting system includes a housing including a front, a rear, a top, a bottom, a first side, and a second side, where the front, rear, top, bottom, first side, and second side define an interior of the housing; a plurality of caster wheels coupled to the housing for rolling along a ground surface during transport; a plurality of voting portals arranged in the housing and including at least a first portal, a second portal, and a third portal, where each of the plurality of portals includes a user interface and user inputs configured to provide a voting function; a plurality of doors associated with each of the plurality of portals, the plurality of doors being movably coupled to the housing between a closed position and an open position; a plurality of printers located in the interior of the housing, where each of the plurality of portals includes one of the plurality of printers; and a ballot storage compartment located in the housing; wherein, when the plurality of doors is located in their open position, each of the plurality of portals is accessible for performing a voting function; wherein, when the plurality of doors is located in their closed position, each of the plurality of voting portals is covered by the plurality of doors.

In a first example of this embodiment, the user interface comprises a touchscreen. In a second example, the first portal is located in the front, the second portal is located in the first side, and the third portal is located in the second side. In a third example, at least two of the plurality of portals is located in the front. In a fourth example, each of the plurality of doors is movable to its open position and oriented in a substantially perpendicular arrangement relative to the housing to form a privacy shield around the respective voting portal. In another example, the first voting portal and second voting portal are arranged in the housing at different heights, the first voting portal being located at a greater height than the second voting portal such that the second voting portal is configured to be accessed by a wheelchair-bound user.

In a further embodiment of the present disclosure, a transportable voting system, includes a housing including a front, a rear, a top, a bottom, a first side, and a second side, where the front, rear, top, bottom, first side, and second side define an interior of the housing; a plurality of caster wheels coupled to the housing for rolling along a ground surface during transport; a plurality of voting portals arranged in the housing, where each of the plurality of portals includes a user interface and user inputs configured to provide a voting function; and a plurality of doors associated with each of the plurality of portals, the plurality of doors being movably coupled to the housing between a closed position and an open position; wherein, when the plurality of doors is located in their open position, each of the plurality of portals is accessible for performing a voting function; wherein, when the plurality of doors is located in their closed position, each of the plurality of voting portals is covered by the plurality of doors; further wherein, the plurality of portals comprises at least a first portal arranged at a first height in the housing and a second portal arranged at a second height in the housing, the first height being greater than the second height, the second portal being located at the second height to be accessed by a wheelchair-bound user.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 illustrates a front view of a first embodiment of a transportable voting system;

FIG. 2 illustrates a front perspective view of the system of FIG. 1;

FIG. 3 illustrates a rear perspective view of the system of FIG. 1; and

FIG. 4 illustrates a perspective view of a second embodiment of a transportable voting system.

Corresponding reference numerals are used to indicate corresponding parts throughout the several views.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The present disclosure relates to a voting station, vote station, or voting system. In this disclosure, one or more embodiments of a voting system may provide a voting jurisdiction the ability to store, secure and transport all of their voting equipment and supplies in one location. The voting system may also allow these jurisdictions to vote directly from the system. In doing so, the voting jurisdiction may have the advantage of setting up and testing all of their equipment in their warehouse before sending it out to polling locations. This in turn can make it easier on election judges and poll workers, who for preparing the system for voting, may only be required to plug in the system so it is ready to vote. Thus, the embodiments of the present disclosure may not require unpacking, setting up and trying to figure out how everything is put together.

The voting system of the present disclosure may also provide the ability to securely store all of their election equipment and supplies overnight. This eliminates having to disassemble the system, pack it up and find somewhere to securely store it for a period of time and then set it up all over again the next time, as this process is repeated generally every day during the early voting period if a conventional vote station is used.

The voting system of the present disclosure is designed to house any voting system, whether it is Election Systems and Software (ES&S), Dominion Voting Systems or Hart Intercivic.

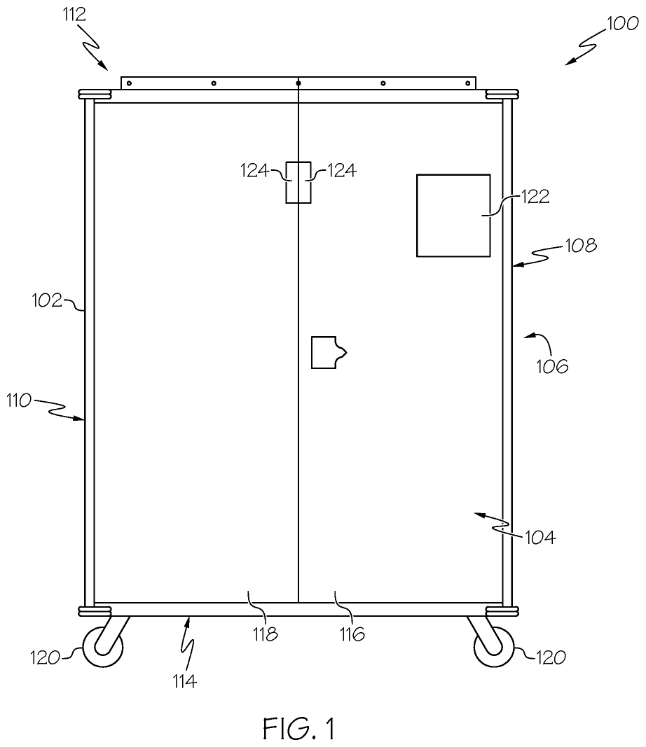

Turning now to FIG. 1 of the present disclosure, one embodiment of a transportable voting system 100 is shown. The system 100 may comprise an outer housing 102 formed as a cabinet or the like. The housing 102 may include a plurality of caster wheels 120 to allow the system to be easily transportable. Each caster wheel 120 may be affixed to a bottom 114 of the housing 102. Moreover, each caster wheel 120 may include a locking device for securely locking the caster wheel from rolling when the voting system 100 is located in a desired stationary location (e.g., when used for performing a voting function). Thus, the voting system 100 may be configured in a working (or use) position and a transport position. When in the transport position, the caster wheels 120 may be unlocked, and in the working or use position, the caster wheels 120 may be locked.

The voting system 100 is considered to be transportable, rather than merely portable. For purposes of this disclosure, the voting system 100 is larger and heavier than smaller voting portals that can be easily collapsed or folded and then carried out of a polling station. These conventional voting portals are portable, but generally must be collapsed or disassembled before being portable. The voting system 100 of the present disclosure, however, is transportable, which is understood to mean it is much larger than the conventional voting portals and is capable of being transported from one location to another without collapsing or being folded into a smaller size. Moreover, the voting system 100 is generally not disassembled into a smaller size for transport.

The housing 102 may include a front 104, a rear 106, a first side 108, a second side 110, a top 112, and the aforementioned bottom 114. Together, each end or side of the housing 102 forms an inner chamber for housing voting equipment and the like, as to be described further below.

The system 100 may include one or more cabinets with at least a first door 116 and a second door 118. As shown, the second door 118 may include a window or screen 122. In the event it is a screen 122, information may be displayed or communicated. A handle or latch 124 may be provided for securely opening or closing each door.

The voting system 100, or alternatively referred to as vote center, may be used to store, transport, and secure all equipment and supplies needed for early voting and/or election day. The system 100 can capably serve as the designated work area and voting center for each polling location and at the warehouse. Advantageously, the system 100 is capable of being relocated or transported as needed.

The voting system 100 also ensures safe and secure movement of election equipment and supplies to and from the polling location and allows a plurality voters to vote directly from it while providing privacy to any other voters voting from it at the same time.

The voting system 100 may be designed to accommodate between one and four voting stations. In FIGS. 1-3, for example, the voting system 100 may include at least two voting stations such that at least two individual voters may cast votes simultaneously while also ensuring privacy to those casting votes.

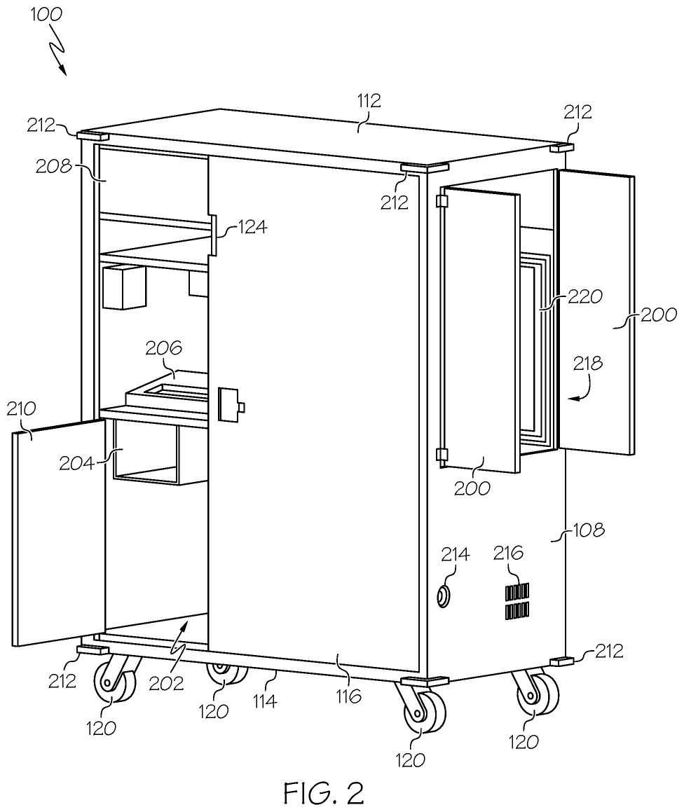

The voting system 100 may also accommodate any type of tabulating system, scanning device, print system, and/or ballot box. In FIG. 2, for example, the voting system 100 shows a storage compartment 202 for ballots, a secondary storage compartment 204 for ballots, a scanner 206, and an extra ballot compartment 208 located within a single side of the housing 102. Other equipment including printers and a ballot marking device.

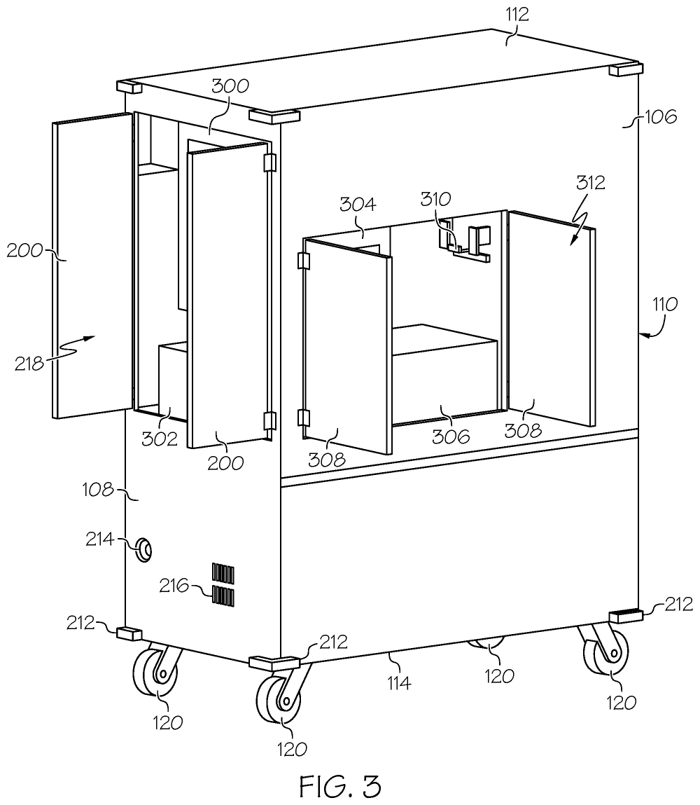

The voting system 100 may also provide a privacy shield in the form of the doors to be used when voters are casting a vote or to keep information and the like confidential. As shown in at least FIGS. 2 and 3, each of the sets of doors is arranged substantially perpendicular to the housing 102 in their open positions. For instance, the doors 200 on the first side 108 are positioned substantially perpendicular to a plane defined by the first side 108. As such, the doors 200 form a privacy shield for a user who approaches and uses the voting portal 218 to cast a vote. The doors 200 partially form walls on each side of the user during the voting process. In an alternative embodiment, the doors may be arranged substantially between 60° and 120° to form the privacy shield. For purposes of this disclosure, the term “substantially” may be defined to be within 5-10% of a number or range.

As shown, the doors 200 may be pivotally or hingedly coupled to the housing 102. Alternatively, the doors may be slidably coupled to the housing. Further, the doors of the voting system 100 may be coupled to the housing in other known manners.

As shown in FIG. 2, an electrical outlet 214 and vents 216 for ventilating the inner compartments of the system 100 may also be provided. The outlet 214 may be used for connecting to a power source for providing electrical power to the voting and other equipment stored in the housing 102.

The voting system 100 may be compartmentalized to maximize storage space for tabulation systems, voting booths, electronic pollbooks, printers, ballot boxes, and any other peripheral items necessary at the polling locations.

A pair of side doors 200 may be provided for securely covering a voting portal or interface 218. The voting portal or interface 218 may be a designated voting station where a voter may cast a vote. The voting portal may include a screen 220 with a plurality of buttons or user inputs (not shown) for making selections.

The storage compartment 202 may be enclosed by a door 210, as shown. Other doors (not shown) may enclose the secondary ballot storage 204, scanner 206, and extra ballot compartment 208.

The outer housing 102 may include corner bumpers 212 located at each corner along the top 112 and bottom 114 thereof. These bumpers 212 may be formed of a rubber or plastic material to protect the voting system 100 and its equipment in the event it comes into contact with a wall, door, or other object during transport. Other mechanisms may be employed to protect the voting system 100 during transport as well.

Turning to FIG. 3, the voting system 100 is illustrates the voting portal 218 or interface located on the first side 108 of the housing 102. The voting portal 218 is shown including a ballot marking device 300 such as a touchscreen or a screen with a plurality of user inputs (e.g., buttons, switches, knobs, levers, etc.). The voting portal 218 may also include a printer 302, as shown. In at least one embodiment, each voting portal includes a ballot marking device 300 and a printer 302, as illustrated in FIG. 3.

The voting system 100 may also include a second voting portal or interface 312 located on the rear 106 of the housing 102. The second voting portal 312 may include, for example, a second ballot marking device 304 (e.g., a screen, user inputs, etc.), a printer 306, and doors 308 for enclosing the device 304 and printer 306 when not in use (e.g., during transport). The system 100 may also accommodate a privacy shield, which is shown in FIG. 2 as part of the doors 308. The doors 308 or privacy shield may include security seals for securely sealing the doors 308 to the rear 106 when closed. The positioning of various features may also be ADA compliant.

The voting system 100 may also advantageously be designed to accommodate physically-disabled voters or those who may in a wheelchair. In other words, the voting system 100 may be compliant with the Americans with Disabilities Act of 1990, or the ADA. For instance, the first voting portal 218 may be positioned at a height of at least 48 inches or higher. Thus, a voter may be required to stand to access and use the voting portal 218. The second voting portal 312, however, may be positioned lower such that a person in a wheelchair may be able to access and use the voting portal 312. The system 100 may include an ADA-compliant pad and headset 310.

The voting system 100 may come fully assembled, and can be constructed from steel or aluminum. Titanium, plastic, or other material may also be used for constructing the outer housing 102. One of the sides of the housing may include one or more slots for receiving paper ballots.

The structural support and rigidity of the system is shown in FIGS. 1-3. Four retaining angles, one on each side, may be provided along with the corner bumpers 212. With the system 100 being made from steel, aluminium, titanium, or any other robust material, the voting system 100 is durable as well as easily movable.

The interior of the voting system 100 may be enclosed with one or more doors on one of the front, rear, or sides being open. The voting system 100 may include one or more shelves to support the electrical computing equipment, including the voting equipment necessary to receive and cast votes. One or more fans, blowers, or air conditioners may also be incorporated with the voting system 100 to ensure the equipment is cooled and is not exposed to dust, dirt and debris.

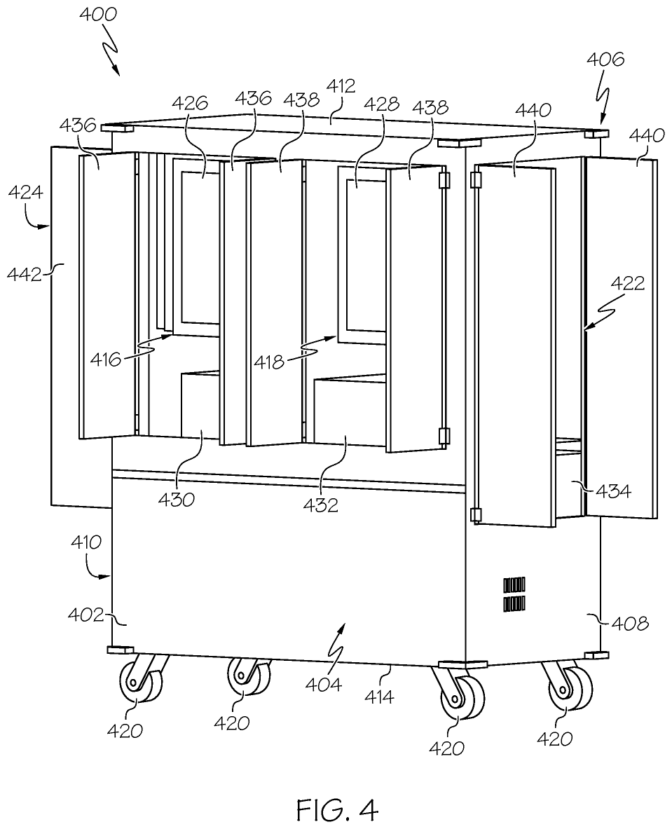

Referring to FIG. 4, another embodiment of a transportable voting system is shown. Here, the voting system 400 is similar to the voting system 100 of FIG. 1, except that it includes additional voting portals and equipment. The multi-voting portal voting system 400 of FIG. 4 may comprise an outer housing formed as a cabinet that is movable via caster wheels 420 coupled to a bottom 414 thereof. The housing 402 may include a front 404, a rear 406, a first side 408, a second side 410, a top 412, and a bottom 414.

In FIG. 4, the voting system 400 may include a first voting portal 416, a second voting portal 418, a third voting portal 422, and a fourth voting portal 424. For purposes of this disclosure, the voting system may include a plurality of voting portals, and the examples of FIGS. 1-4 are not intended to be limiting. In at least one example, there may be three or more portals. In another example, there may be five or more portals. Thus, the number of portals available is not intended to be limiting to the present disclosure.

Each voting portal may include a screen, user inputs, and other voting equipment. For instance, the first voting portal 416 may include a first screen 426 and a first printer 430. The second voting portal 418 may include a second screen 428 and a second printer 432. The third portal 422 may include a screen (not shown) and a printer 434. Other equipment such as scanners, tabulators, computer processing equipment, copy or fax machines, ballot boxes, fans, blowers, or air conditioners may be provided. ADA equipment including Pads or headsets may be provided. Each screen may be a touchscreen. Alternatively, each portal may include buttons, switches, knobs, levers, and the like for making selections, and the associated screen may display information such as candidate names, etc.

The system may include doors and other privacy shields for each portal. For example, the first portal 416 may include a set of doors 436 or shields to maintain privacy. Likewise, the second portal 418 may include a set of doors 438, the third portal 422 may include a set of doors 440, and the fourth portal 424 may include a set of doors 442.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A transportable voting system, comprising:
a housing including a front, a rear, a top, a bottom, a first side, and a second side, where the front, rear, top, bottom, first side, and second side define an interior of the housing;
a plurality of caster wheels coupled to the housing for rolling along a ground surface during transport;
a plurality of voting portals arranged in the housing, each of the plurality of portals including a user interface and user inputs configured to provide a voting function; and
a plurality of doors associated with each of the plurality of voting portals, the plurality of doors being movably coupled to the housing;
wherein, the plurality of doors are movable between an open position and a closed position;
wherein, when the plurality of doors is located in their open position, each of the plurality of voting portals is accessible for performing a voting function and the plurality of doors are configured to provide privacy to each voting portal;
further wherein, when the plurality of doors is located in their closed position, each of the plurality of voting portals is inaccessible.

2. The system of claim 1, wherein each of the plurality of voting portals comprises a screen and at least one user input for casting a vote.

3. The system of claim 1, wherein the plurality of voting portals are arranged in the interior of the housing.

4. The system of claim 1, wherein at least one voting portal is located in the front and a second voting portal is located in one of the first side and second side.

5. The system of claim 1, wherein at least two voting portals are located in the front.

6. The system of claim 1, wherein the plurality of voting portals comprises a first voting portal, a second voting portal, and a third voting portal, where the first voting portal is located in the front, the second voting portal is located in the first side, and the third voting portal is located in the second side.

7. The system of claim 6, further comprising a fourth voting portal of the plurality of voting portals, wherein the fourth voting portal is located in the front adjacent the first voting portal.

8. The system of claim 7, wherein the plurality of doors comprises a first pair of doors and a second pair of doors, the first pair of doors covering the first voting portal in the closed position and the second pair of doors covering the fourth voting portal in the closed position.

9. The system of claim 7, further comprising an additional voting portal located in the rear.

10. The system of claim 1, wherein each of the plurality of doors is movable to its open position and oriented in a substantially perpendicular arrangement relative to the housing to form a privacy shield around the respective voting portal.

11. The system of claim 1, further comprising a printer for each of the plurality of voting portals.

12. The system of claim 1, wherein the plurality of voting portals at least a first voting portal and a second voting portal, the first voting portal and second voting portal arranged in the housing at different heights such that the voting portal at a lower height is configured to be accessed by a wheelchair-bound user.

13. The system of claim 12, wherein the voting portal at the lower height includes a pad and a headset.

14. A transportable voting system, comprising:
a housing including a front, a rear, a top, a bottom, a first side, and a second side, where the front, rear, top, bottom, first side, and second side define an interior of the housing;
a plurality of caster wheels coupled to the housing for rolling along a ground surface during transport;
a plurality of voting portals arranged in the housing and including at least a first portal, a second portal, and a third portal, where each of the plurality of portals includes a user interface and user inputs configured to provide a voting function;
a plurality of doors associated with each of the plurality of portals, the plurality of doors being movably coupled to the housing between a closed position and an open position;
a plurality of printers located in the interior of the housing, where each of the plurality of portals includes one of the plurality of printers; and
a ballot storage compartment located in the housing;
wherein, when the plurality of doors is located in their open position, each of the plurality of portals is accessible for performing a voting function;
wherein, when the plurality of doors is located in their closed position, each of the plurality of voting portals is covered by the plurality of doors.

15. The system of claim 14, wherein the user interface comprises a touchscreen.

16. The system of claim 14, wherein the first portal is located in the front, the second portal is located in the first side, and the third portal is located in the second side.

17. The system of claim 14, wherein at least two of the plurality of portals is located in the front.

18. The system of claim 14, wherein each of the plurality of doors is movable to its open position and oriented in a substantially perpendicular arrangement relative to the housing to form a privacy shield around the respective voting portal.

19. The system of claim 14, wherein the first voting portal and second voting portal are arranged in the housing at different heights, the first voting portal being located at a greater height than the second voting portal such that the second voting portal is configured to be accessed by a wheelchair-bound user.

20. A transportable voting system, comprising:
a housing including a front, a rear, a top, a bottom, a first side, and a second side, where the front, rear, top, bottom, first side, and second side define an interior of the housing;
a plurality of caster wheels coupled to the housing for rolling along a ground surface during transport;
a plurality of voting portals arranged in the housing, where each of the plurality of portals includes a user interface and user inputs configured to provide a voting function; and
a plurality of doors associated with each of the plurality of portals, the plurality of doors being movably coupled to the housing between a closed position and an open position;
wherein, when the plurality of doors is located in their open position, each of the plurality of portals is accessible for performing a voting function;
wherein, when the plurality of doors is located in their closed position, each of the plurality of voting portals is covered by the plurality of doors;
further wherein, the plurality of portals comprises at least a first portal arranged at a first height in the housing and a second portal arranged at a second height in the housing, the first height being greater than the second height, the second portal being located at the second height to be accessed by a wheelchair-bound user.
